(19) United States
(12) Patent Application Publication
(10) Pub. No.: US 2024/0079793 A1
(43) Pub. Date: Mar. 7, 2024

(54) REFLECTOR FOR MILLIMETRIC WAVES

(71) Applicant: Univeritat Politecnica de Valencia, Valencia (ES)

(72) Inventors: Narcis Cardona Marcet, Valencia (ES); Jhoan Samuel Romero Pena, Valencia (ES)

(73) Assignee: Univeritat Politecnica de Valencia, Valencia (ES)

(21) Appl. No.: 18/262,584

(22) PCT Filed: Dec. 20, 2021
(86) PCT No.: PCT/ES2021/070909

§ 371 Date: Jul. 24, 2023

(30) Foreign Application Priority Data
Jan. 27, 2021 (ES) P202130068

(51) Int. Cl. H01Q 15/16

(52) U.S. Cl. CPC H01Q 15/16

(57) ABSTRACT

A reflector for millimetric waves having at least one reflector element including a concave or substantially concave surface, is configured according to a polygonal or substantially polygonal shape, and is modular. More specifically, a reflector designed to be hexagonally modular is presented, being able to adapt to any flat surface, regardless of its dimensions, such as walls or ceilings; wherein each piece of the modular reflector comprises a concave surface.

### CROSS REFERENCE TO RELATED APPLICATION

This application is a national stage entry of PCT/ES2021/070909 filed Dec. 20, 2021, under the International Convention and claiming priority over Spain Patent Application No. P202130068 filed Jan. 27, 2021.

### TECHNICAL FIELD

The present invention is framed in the field of telecommunications, more specifically, in the field of the reflector components for telecommunications waves, and more specifically to the modular reflector components for mobile telephony in millimetric waves.

### PRIOR ART OF THE INVENTION

Currently, mobile devices with direct internet connection are widely used, due to their accessibility and portability. In addition, this use is constantly expanding, demanding ever greater bandwidth, not only in particular applications, but also in the implementation of new technologies, such as 5G networks, automated driving, or IoT platforms, which will only be viable in the millimetric waves spectrum.

The current problems of working in the millimetric waves spectrum are well known, such as propagation losses, with very high incidence in the free space. When using this frequency band, the propagation losses in the free space with direct line of sight (LOS) are very high, essentially due to the frequency range in which the millimetric waves operate (26 GHz to 40 GHz).

Additionally, propagation in this frequency band is very susceptible to any type of obstacle, being electrically larger so that the visibility between the transmitter and receiver is poor (NLOS). Consequently, propagation losses are higher than those initially determined in the free space with direct line of sight (LOS).

Different solutions to reduce NLOS losses in indoor environments are state-of-the-art, such as Beam-Forming, which uses multiple antennas to achieve the best unobstructed path; or Beam-Steering, which seeks to modify the direction of the main lobe of a radiation pattern, for example, by changing the antenna elements. However, these solutions involve complex and expensive technologies, which are not feasible in the short term.

Likewise, it is possible to find different documents belonging to the state of the art, related to the reflectors for millimetric waves.

We can find document U.S. Pat. No. 4,403,222, which describes a passive device that diverts electromagnetic energy from an original path to a new one located at a 90° angle, using a modified Yagii-Uda parasitic array to excite a cross dipole element that re-radiates the energy in a second direction.

Also in the prior art is document US20110063181, which describes a small antenna device that acts as a passive repeater and is designed to facilitate radio frequency (RF) signal gain.

Finally, also pertaining to the prior art is document US2012206299, which describes a reflector system comprising: a setting mechanism connected to a mounting point on an object or surface; a reflecting surface that reflects millimetric waves radiation; and an adjustable pivot connected between the setting mechanism and the reflecting surface, configured to allow directional positioning of the reflecting surface relative to the setting mechanism. This achieves a non-line-of-sight (NLOS) connection between a millimetric waves transmitter and a millimetric waves receiver.

However, the different millimetric waves reflection systems that can be found in the state of the art propose technologically and economically expensive solutions, which are additionally energy inefficient and inflexible to adapt to the conditions of any closed environment.

### SUMMARY OF THE INVENTION

Thus, the Reflector for millimetric waves that the invention proposes is configured, therefore, as an outstanding novelty within its field of application, since according to its implementation and in a taxable manner the objectives that will be indicated below are satisfactorily achieved, being the characterizing details, which make it possible and which distinguish them, conveniently collected in the final claims accompanying the present description.

In particular, the present invention refers to a modular reflector for mobile telephony in millimetric waves, whose purpose is to disperse the electromagnetic energy over a wide coverage area, regardless of the angle of incidence on it. This maximizes the coverage of the radio channel, offering an alternative path to the signal in order to avoid fading generated by obstacles in the environment.

For this purpose, the modular reflector object of the present invention comprises at least one millimetric waves reflector element, which will be polygonal in shape, preferably a hexagon, configuring a concave surface that facilitates the dispersion of the reflected waves, with the objective of providing coverage in areas without signal (NLOS), and which will be passive, that is, without the need to use electronic or mechanical elements for its correct operation.

In this way, the reflector is modular and can be composed of one or as many reflector elements as necessary, being able to adapt its dimensions and composition to the specific requirements of each room, forming a modular structure based on the polygonal shape described above, which can be multiplied as many times as required.

Following the above reasoning, the final size of the reflector will depend on the number of elements to be used together, depending on the area to be covered on a flat surface.

In addition, depending on the electromagnetic requirements, the surface may be irregular, ensuring the homogeneity of the scattering of the reflector's output radiation as well as the operating bandwidth of the reflector.

To achieve the desired effect, the surface of each reflector element must be metallized, either by being a metallic surface itself, or by including a metallized coating with low surface electrical resistance.

In an example embodiment, the diffuse reflector for millimetric waves subject of the present invention will be positioned at the top of an interior room, typically the ceiling or top cover, so as to maximize the area covered by it. However, it may also be installed on any flat surface, such as a wall.

Taking up the above, the present invention proposes a diffuse reflector comprising at least one reflector element, which may comprise as many as necessary according to the electromagnetic requirements of the room, which will have a concave-shaped metallized surface, and which may be, additionally, of irregular shape to ensure homogeneity in the dispersion of the output radiation of the reflector assembly.

In this way, a passive modular diffuse hexagonal reflector for millimetric waves is achieved, whose purpose is to distribute the electromagnetic energy in an area orthogonal to the orientation of the reflector, with the objective of providing diversity in the coverage in millimetric waves.

For this reason, the reflector for millimetric waves and the set of elements described represent an innovation with structural and constitutive characteristics hitherto unknown, reasons which, together with its practical utility, provide it with sufficient grounds to obtain the exclusivity privilege requested.

### BRIEF DESCRIPTION OF THE DRAWINGS

To complement the description being made and in order to assist in a better understanding of the features of the invention, a set of drawings is attached as an integral part of said description, wherein the following is shown for illustrative purposes and non-limiting purposes:

FIG. 1.—Example of a hexagonal modular structure of reflector elements on a flat surface.

FIG. 2.—Example of the single hexagonal reflector from a zenith view.

FIG. 3.—Example of the single hexagonal reflector from a side view.

FIG. 4.—Example of application of the invention in an interior room with obstructive elements, where the modular structure of reflectors redistributes the incident energy in a direction perpendicular to the orientation of the reflector. Generating a shower effect on a specific area of coverage independent of the angle of incidence.

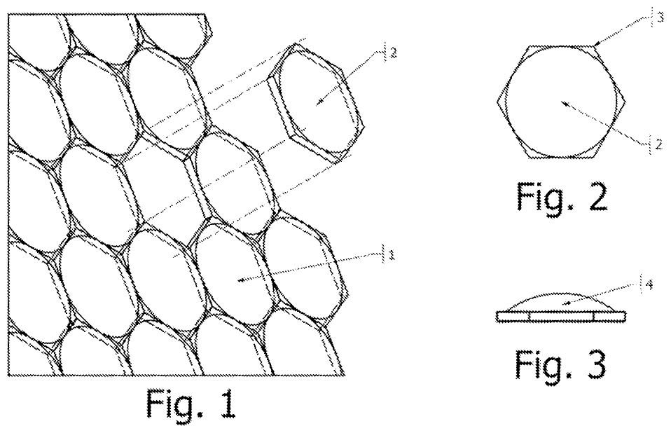

### LIST OF REFERENCES AND FIGURES

1. Modular structure of several reflector elements
2. Concave surface of the reflector element
3. Hexagonal polygonal shape of the individual reflector element
4. Concave surface of the reflector
5. Top cover (Roof)
6. Lateral enclosure (Wall)
7. Lower enclosure (Floor)
8. Obstacles of the interior environment (furniture, people, etc.)
9. Directional millimetric waves emitter
10. Mobile millimetric waves receiver for mobile communications

### PREFERRED EMBODIMENT OF THE INVENTION

In the following detailed description of preferred embodiments, reference is made to the attached drawings which form part of this report, showing by way of illustration specific preferred embodiments in which the invention can be carried out. These embodiments are described in sufficient detail to enable those skilled in the art to carry out the invention, and it is understood that other embodiments may be used and that logical structural, mechanical, electrical and/or chemical changes may be made without departing from the scope of the invention. In order to avoid details not necessary to enable those skilled in the art to carry out the detailed description it must not, therefore, be taken in a restrictive sense.

Specifically, the present invention poses a Reflector for millimetric waves comprising at least one reflector element 1, characterized in that:
comprises a concave or substantially concave surface 4.
is configured according to a polygonal 3 or substantially polygonal shape, preferably a hexagon.
and is modular, i.e., it can be joined to other reflector elements to configure a joint structure that adapts to the requirements of the room in which it is installed, being able to cover a larger or smaller area depending on the number of coupled reflector elements.

In this way, a millimetric waves reflector is proposed that achieves a homogeneous dispersion of the reflected waves along a wide coverage surface, and that, coupled in the top cover 5 or side enclosure 6 of an interior room, according to the coverage needs of the room and the location of the millimetric waves directional emitter 9.

In a preferred embodiment, the reflector will be passive, i.e. it will not have any external electronic and/or mechanical elements connected to it, so that it can operate independently, without requiring additional connections.

In another preferred embodiment, the surface 2 will be irregular, i.e., it will comprise a given roughness, so as to combine the contributions of the reflector, in a pseudo-random manner, to ensure homogeneity of coverage over a specified bandwidth in the range of the millimeter frequencies of the reflector's reflector.

In another preferred embodiment, the surface 2 of each reflector element will be metallized, being a metallic element itself, or comprising a metallic surface coating, so as to achieve optimum reflection of electromagnetic waves, which could not be achieved with other types of non-conductive materials.

Preferably, each reflector element will comprise a concave surface 2 with a dimension between 2 cm and 7 cm per side of the hexagonal base, and between 4 cm and 10 cm radius of the circular concave surface.

Likewise, the reflector element will have a curvature whose limit is a crosswise cutting between 40% and 70% of the radius of the unit circumference.

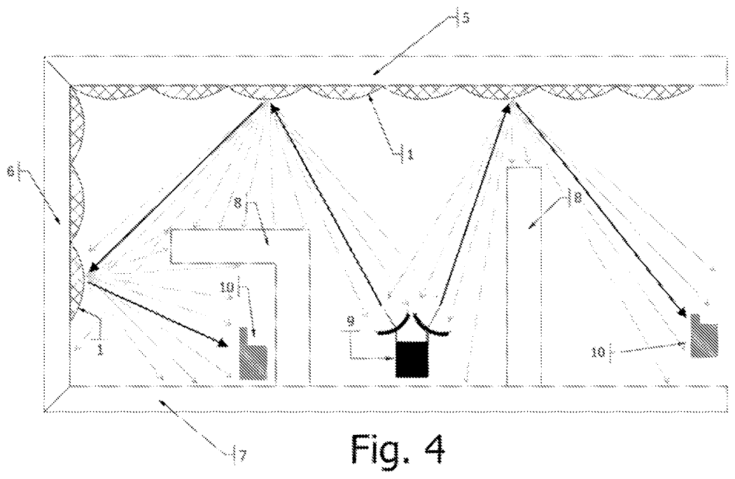

In an example of application, and as can be seen in FIG. 4, the reflector object 1 of the present invention will comprise at least one reflector element 2, which will be installed on the top cover 5 or side enclosure 6 of an interior room, in which there is an emitter 5, and an indefinite number of obstacles 8, so that the emitter 5 emits electromagnetic waves, and the reflector object 1 scatters the electromagnetic wave radiation in the millimetric waves band over a wide coverage area in order to reach the areas obstructed by the obstacles 8 in the environment.

The industrial application of the present invention derives evident from the explanation made, posing a modular passive reflector that allows the dispersion of electromagnetic energy in millimetric waves, over a wide coverage area, in order to offer diversity in the propagation in the radio channel in indoor environments.

Having sufficiently described the nature of the present invention, as well as the manner of putting it into practice, it is not considered necessary to further explain it so that any person skilled in the art may understand its scope and the advantages derived therefrom, it being noted that, within its essential nature, it may be put into practice in other forms of realization that differ in detail from the one indicated by way of example, and to which the protection claimed will also apply provided that its fundamental principle is not altered, changed or modified.

1. A reflector for millimetric waves comprising:
at least one reflector element having:
at least one concave or substantially concave surface,
is configured to a polygonal or substantially polygonal shape, and
is modular.

2. The reflector for millimetric waves according to claim 1, wherein the reflector is free of connections to external electronic and/or mechanical elements.

3. The reflector for millimetric waves according to claim 1, wherein the polygonal shape is a hexagon.

4. The reflector for millimetric waves according to claim 1, wherein the surface is irregular.

5. The reflector for millimetric waves according to claim 1, wherein the surface is metallized.

6. The reflector for millimetric waves according to claim 5, wherein the surface is a metal.

7. The reflector for millimetric waves according to claim 5, wherein the surface has a metallic coating.

8. The reflector for millimetric waves according to claim 1, wherein the hexagon has hexagon sides having a dimension between 2 cm and 7 cm.

9. The reflector for millimetric waves according to claim 1, wherein the concave surface has a radius dimension between 4 cm and 10 cm.

10. The reflector for millimetric waves according claim 1, wherein the reflector has a curvature whose limit is a crosswise cutting between 40% and 70% of a radius of the reflector circumference.
